(19) United States
(12) Patent Application Publication
(10) Pub. No.: US 2007/0034576 A1
(43) Pub. Date: Feb. 15, 2007

(54) Method for separating a homogeneous catalyst

(75) Inventors: Wolfram Stuer, Bukit Bandaraya (MY); Jens Scheidel, Hirschberg (DE); Hartwig Voss, Frankenthal (DE); Peter Bassler, Viernheim (DE); Michael Roper, Wachenheim (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 10/561,613

(22) PCT Filed: Jun. 11, 2004
(86) PCT No.: PCT/EP04/06301

§ 371 Date: Dec. 20, 2005

(30) Foreign Application Priority Data
Jun. 25, 2003 (DE) 103 28 713.2

(51) Int. Cl. B01D 61/00

(52) U.S. Cl. 210/767

(57) ABSTRACT

A process for separating a mixture comprising a) a monoolefinically unsaturated compound which is obtainable by adding two terminal olefins which bear the functional groups required to prepare the monoolefinically unsaturated compound containing at least two functional groups, or a saturated compound obtained by hydrogenating such a compound, b) a compound which is obtainable by adding more than two of the terminal olefins mentioned in a) or a compound obtained by hydrogenating such a compound, and c) a compound which contains a transition metal, is homogeneous with respect to the mixture and is suitable as a catalyst for preparing a monoolefinically unsaturated compound by adding two terminal olefins which bear the functional groups required to prepare the monoolefinically unsaturated compound containing at least two functional groups, by means of a semipermeable membrane to obtain a permeate and a retentate in such a way that the weight ratio of component b) to component c) in the mixture fed to the semipermeable membrane is smaller than in the retentate.

The present invention relates to a process for separating a mixture comprising
a) a monoolefinically unsaturated compound which is obtainable by adding two terminal olefins which bear the functional groups required to prepare the monoolefinically unsaturated compound containing at least two functional groups, or a saturated compound obtained by hydrogenating such a compound,
b) a compound which is obtainable by adding more than two of the terminal olefins mentioned in a) or a compound obtained by hydrogenating such a compound, and
c) a compound which contains a transition metal, is homogeneous with respect to the mixture and is suitable as a catalyst for preparing a monoolefinically unsaturated compound by adding two terminal olefins which bear the functional groups required to prepare the monoolefinically unsaturated compound containing at least two functional groups,
   by means of a semipermeable membrane to obtain a permeate and a retentate in such a way that the weight ratio of component b) to component c) in the mixture fed to the semipermeable membrane is smaller than in the retentate.

Numerous compounds which bear two functional groups which are each independently selected from the group consisting of nitrile group, carboxylic acid group, carboxylic ester group and carboxamide group have great industrial significance.

For example, adipic acid or its derivatives constitute important starting compounds for preparing industrially important polymers such as nylon-6 or nylon-6,6.

Such compounds may be obtained, for example, by adding two terminal olefins which bear the functional groups required to prepare the monoolefinically unsaturated compound containing at least two functional groups.

For instance, hexenedioic diesters can be prepared by adding acrylic ester in the presence of appropriate catalyst systems, in particular homogeneous, rhodium-containing catalyst systems, as described, for example, in J. Organomet. Chem. 1987, 320, C56, U.S. Pat. No. 4,451,665, FR 2,524,341, U.S. Pat. No. 4,889,949, Organometallics, 1986, 5, 1752, J. Mol. Catal. 1993, 85, 149, U.S. Pat. No. 4,594,447, Angew. Chem. Int. Ed. Engl., 1988, 27. 185, U.S. Pat. No. 3,013,066, U.S. Pat. No. 4,638,084, EP-A-475 386, JACS 1991, 113, 2777-2779, JACS 1994, 116, 8038-8060.

Such an addition of two terminal olefins which bear the functional groups required to prepare the monoolefinically unsaturated compound containing at least two functional groups provides monoolefinically unsaturated compounds which bear at least two functional groups which are each independently selected from the group consisting of nitrile group, carboxylic acid group, carboxylic ester group and carboxamide group. Hydrogenation provides the corresponding saturated compounds from such monoolefinically unsaturated compounds.

For a process which can be carried out industrially and is economically viable, it is desirable to be able to recover the catalyst from the product stream, preferably in a manner which enables recycling into the addition reaction. If desired, for example in the case of the preferred noble metal catalysts, the noble metal can also be recovered from the back-recovered catalyst.

The prior art does not disclose processes for such a removal of the catalyst from the product stream mentioned.

It is an object of the present invention to provide a process which enables the removal of a compound which is obtainable by adding more than two two terminal olefins which bear the functional groups required to prepare the monoolefinically unsaturated compound containing at least two functional groups and at the same time has a small depletion in a compound which contains a transition metal, is homogeneous with respect to the mixture and is suitable as a catalyst for preparing a monoolefinically unsaturated compound by adding two terminal olefins which bear the functional groups required to prepare the monoolefinically unsaturated compound containing at least two functional groups from the product stream of such an addition reaction. This separation task should be solved in a technically simple and economically viable manner.

We have found that this object is achieved by the process as defined at the outset.

The structures which are referred to as catalyst in the context of the present invention relate to the compounds which are used as a catalyst; the structures of the catalytically active species under the particular reaction conditions may differ therefrom, but are also included by the term “catalyst” mentioned.

The product stream fed to the semipermeable membrane for separation comprises
a) a compound which is obtained by monoaddition of the two terminal olefins mentioned and bears at least two functional groups which are each independently selected from the group consisting of nitrile group, carboxylic acid group, carboxylic ester group and carboxamide group, or a saturated compound obtained by hydrogenating such a compound,
b) a compound obtained by adding more than two, preferably more than three, of the two terminal olefins mentioned, or a compound obtained by hydrogenating such a compound and
c) a compound which is suitable as a catalyst for this addition and is homogeneous with respect to the reaction mixture.

In the context of the present invention, a compound a) refers to a single such compound or to a mixture of such compounds.

In the context of the present invention, a compound b) refers to a single such compound or to a mixture of such compounds.

In the context of the present invention, a compound c) refers to a single such compound or to a mixture of such compounds.

The terminal olefins used may advantageously be two identical or different, preferably identical, olefins which each independently have the formula H₂C═CHR¹ in which R¹ is a nitrile group, carboxylic acid group, carboxylic ester group or carboxamide group, preferably carboxylic ester group or nitrile group.

In the case of the carboxylic ester group, advantageous compounds are esters of aliphatic, aromatic or heteroaromatic alcohols, in particular aliphatic alcohols. The aliphatic alcohols which can be used are preferably C₁-C₁₀-alkanols, in particular C₁-C₄-alkanols, such as methanol, ethanol, isopropanol, n-propanol, n-butanol, i-butanol, s-butanol, t-butanol, more preferably methanol.

The carboxamide groups may be N- or N,N-substituted, and the N,N-substitution may be identical or different, preferably identical. Useful substituents are preferably aliphatic, aromatic or heteroaromatic substituents, in particular aliphatic substituents, more preferably C₁-C₄-alkyl radicals, such as methyl, ethyl, i-propyl, n-propyl, n-butyl, i-butyl, s-butyl, t-butyl, more preferably methyl.

In an advantageous embodiment, the terminal olefin having a functional group which is used may be acrylic acid or its esters. The preparation of acrylic acid, for example by gas phase oxidation of propene or propane in the presence of heterogeneous catalysts, and the preparation of acrylic esters, for example by esterification of acrylic acid with the appropriate alcohols in the presence of homogeneous catalysts such as p-toluenesulfonic acid, are known per se.

When acrylic acid is stored or processed, it is customary to add one or more stabilizers which, for example, prevent or reduce the polymerization or the decomposition of acrylic acid, such as p-methoxyphenol or 4-hydroxy-2,2,4,4-tetramethylpiperidine N-oxide (“4-hydroxy-TEMPO”).

Such stabilizers can be partly or fully removed before the acrylic acid or its esters are used in the addition step. The stabilizer can be removed by processes known per se, such as distillation, extraction or crystallization.

Such stabilizers may remain in the acrylic acid or its esters in the amount used beforehand.

Such stabilizers may be added to the acrylic acid or its esters before the addition reaction.

When different olefins are used, the addition typically results in mixtures of the different possible addition products.

When one olefin is used, the addition, which in this case is typically referred to as a dimerization, results in one addition product. For economic reasons, this alternative is usually preferred.

In a preferred embodiment, the monoolefinically unsaturated compound which bears at least two functional groups which are each independently selected from the group consisting of nitrile group, carboxylic acid group, carboxylic ester group and carboxamide group is hexenedioic diester, in particular dimethyl hexenedioate, to obtain adipic diester, in particular dimethyl adipate, by hydrogenation.

Adipic acid can be obtained from adipic diester, in particular dimethyl adipate, by cleaving the ester group. Useful processes for this purpose are processes which are for cleaving esters and are known per se.

In a further preferred embodiment, the monoolefinically unsaturated compound which bears at least two functional groups which are each independently selected from the group consisting of nitrile group, carboxylic acid group, carboxylic ester group and carboxamide group is butenedinitrile to obtain adiponitrile by hydrogenation.

In a further preferred embodiment, the monoolefinically unsaturated compound which bears at least two functional groups which are each independently selected from the group consisting of nitrile group, carboxylic acid group, carboxylic ester group and carboxamide group is 5-cyanopentenoic ester, in particular methyl 5-cyanopentenoate, to obtain 5-cyanovaleric ester, in particular methyl 5-cyanovalerate, by hydrogenation.

The addition mentioned of two terminal olefins to obtain the mixture as per step a) may be effected by processes known per se, as described, for example, in J. Organomet. Chem. 1987, 320, C56, U.S. Pat. No. 4,451,665, FR 2,524,341, U.S. Pat. No. 4,889,949, Organometallics, 1986, 5,1752, J. Mol. Catal. 1993, 85, 149, U.S. Pat. No. 4,594,447, Angew. Chem. Int. Ed. Engl., 1988, 27.185, U.S. Pat. No. 3,013,066, U.S. Pat. No. 4,638,084, EP-A-475 386, JACS 1991, 113, 2777-2779, JACS 1994, 116, 8038-8060.

The addition reaction may be partial or complete. Accordingly, in the case of partial conversion, the reaction mixture may comprise unconverted olefin.

The addition reaction may advantageously be carried out in the presence of hydrogen. A hydrogen pressure in the range from 0.1 to 1 MPa has been found to be advantageous.

The addition may advantageously be carried out in the presence of a compound, as a catalyst, which is homogeneous with respect to the reaction mixture and contains rhodium, ruthenium, palladium or nickel, preferably rhodium.

In a preferred embodiment, the mixture obtained in this addition reaction may be hydrogenated to obtain a saturated compound.

The hydrogenation may advantageously be carried out in the presence of a substance, as a catalyst, which is heterogeneous with respect to the reaction mixture.

Useful heterogeneous catalysts are preferably those whose catalytically active component is a noble metal of group 8 of the Periodic Table of the Elements, such as palladium, ruthenium, rhodium, iridium, platinum, nickel, cobalt, copper, preferably palladium.

These metals may be used in unsupported form, for example as a suspension catalyst, preferably in the case of nickel or cobalt.

These metals may be used in supported form, for example on activated carbon, metal oxides, transition metal oxides, in particular aluminum oxide, silicon dioxide, preferably as fixed bed catalysts.

The hydrogenation may advantageously be carried out in the presence of a compound, as a catalyst, which is homogeneous with respect to the reaction mixture and contains rhodium, ruthenium, palladium or nickel, preferably rhodium.

In a preferred embodiment, the addition may be carried out in the presence of the same compound, as a catalyst, which is homogeneous with respect to the reaction mixture and contains rhodium as the hydrogenation mentioned.

In a particularly preferred embodiment, this hydrogenation may be carried out without removing or depleting the homogeneous, rhodium-containing compound used in the addition.

This procedure is of great advantage compared to the prior art since no workup of the reaction effluent obtained in the addition reaction mentioned is required. In a particularly preferred embodiment, the mixture obtained in the addition can be transferred without a workup step to this hydrogenation.

This may be effected, for example, by transferring the mixture obtained in the addition from the reaction apparatus into a further apparatus intended for the hydrogenation, i.e. by a spatial separation of addition and hydrogenation. For example, the addition may be carried out in a reactor such as a stirred tank, a stirred tank battery, or a flow tube, or in a combination of one of these reactor types with a further reactor suitable for the hydrogenation.

This may be effected, for example, by carrying out addition and hydrogenation successively in the same apparatus, i.e. a temporal separation of addition and hydrogenation.

Preference is given to carrying out the addition or the hydrogenation or both in the presence of a rhodium-containing compound, as a catalyst, which is homogeneous with respect to the reaction mixture and is of the formula [L¹RhL²L³R]⁺X⁻ where
L¹ is an anionic pentahapto ligand, preferably pentamethylcyclopentadienyl;
L² is an uncharged 2-electron donor;
L³ is an uncharged 2-electron donor;
R is selected from the group consisting of H, C₁-C₁₀-alkyl, C₆-C₁₀-aryl and C₇-C₁₀-aralkyl ligands;
X⁻ is an uncoordinating anion, preferably one from the group consisting of BF₄⁻, B(perfluorophenyl)₄⁻, B(3,5-bis(trifluoromethyl)phenyl)₄⁻, Al(OR^{F})₄⁻ where R^{F} is identical or different fluorinated or perfluorinated aliphatic or aromatic radicals, in particular perfluoroisopropyl or perfluoro-tert-butyl;
   and where two or three of L², L³ and R are optionally joined.

In a preferred embodiment, L² and L³ may each independently be selected from the group consisting of C₂H₄, CH₂═CHCO₂Me, P(OMe)₃ and MeO₂C—(C₄H₆)—CO₂Me.

In a further preferred embodiment, L² and L³ may be joined together. In this case, L² and L³ together may in particular be acrylonitrile or 5-cyanopentenoic ester.

In a further preferred embodiment, L² and R may be joined together. In this case, L² and R together may in particular be —CH₂—CH₂CO₂Me.

In a further preferred embodiment, L², L³ and R may be joined together. In this case, L², L³ and R together may in particular be MeO₂C(CH₂)₂—(CH)—(CH₂)CO₂Me.

In a particularly preferred embodiment, the addition or the hydrogenation or both may be carried out in the presence of a rhodium-containing compound, as a catalyst, which is homogeneous with respect to the reaction mixture and is selected from the group consisting of

[Cp*Rh(C₂H₄)₂H]⁺BF₄⁻,

[Cp*Rh(P(OMe)₃)(CH₂═CHCO₂Me)(Me)]⁺BF₄⁻,

[Cp*Rh(—CH₂—CH₂CO₂Me)(P(OMe)₃)]⁺BF₄⁻,

[Cp*Rh(MeO₂C(CH₂)₂—(CH—)—(CH₂)CO₂Me)]⁺BF₄⁻,

[Cp*Rh(C₂H₄)₂H]⁺B(3,5-bis(trifluoromethyl)phenyl)₄⁻,

[Cp*Rh(P(OMe)₃)(CH₂═CHCO₂Me)(Me)]⁺B(3,5-bis(trifluoromethyl)phenyl)₄⁻,

[Cp*Rh(—CH₂—CH₂CO₂Me)(P(OMe)₃)]⁺B(3,5-bis(trifluoromethyl)phenyl)₄⁻,

[Cp*Rh(MeO₂C(CH₂)₂—(CH—)—(CH₂)CO₂Me)]⁺B(3,5-bis(trifluoromethyl)phenyl)₄⁻,

[Cp*Rh(C₂H₄)₂H]⁺B(perfluorophenyl)₄⁻,

[Cp*Rh(P(OMe)₃)(CH₂═CHCO₂Me)(Me)]⁺B(perfluorophenyl)₄⁻,

[Cp*Rh(—CH₂—CH₂CO₂Me)(P(OMe)₃)]⁺B(perfluorophenyl)₄⁻ and

[Cp*Rh(MeO₂C(CH₂)₂—(CH—)—(CH₂)CO₂Me)]⁺B(perfluorophenyl)₄⁻

[Cp*Rh(C₂H₄)₂H]⁺Al(ORF)₄⁻,

[Cp*Rh(P(OMe)₃)(CH₂═CHCO₂Me)(Me)]⁺Al(ORF)₄⁻,

[Cp*Rh(—CH₂—CH₂CO₂Me)(P(OMe)₃)]⁺Al(ORF)₄⁻ and

[Cp*Rh(MeO₂C(CH₂)₂—(CH—)—(CH₂)CO₂Me)]⁺Al(ORF)₄⁻,

where R^{F} is identical or different fluorinated or perfluorinated aliphatic or aromatic radicals, in particular perfluoroisopropyl or perfluoro-tert-butyl.

Such catalysts and their preparation may be effected by processes known per se, as described, for example, in EP-A475 386, JACS 1991,113, 2777-2779, JACS 1994, 116, 8038-8060.

The hydrogenation may be carried out in such a way that the monoolefinically unsaturated compound which bears at least two functional groups which are each independently selected from the group consisting of nitrile group, carboxylic acid group, carboxylic ester group and carboxamide group is converted to a saturated compound to obtain the functional groups mentioned. This hydrogenation may advantageously be carried out at a partial hydrogen pressure in the range from 0.01 to 20 MPa. In the hydrogenation, an average mean residence time of the monoolefinically unsaturated compound which bears at least two functional groups which are each independently selected from the group consisting of nitrile group, carboxylic acid group, carboxylic ester group and carboxamide group in the range from 0.1 to 100 hours has been found to be advantageous. In addition, a useful temperature for the hydrogenation is in the range from 30° C. to 160° C.

The hydrogenation may be carried out in such a way that the monoolefinically unsaturated compound which bears at least two functional groups which are each independently selected from the group consisting of nitrile group, carboxylic acid group, carboxylic ester group and carboxamide group is converted to a saturated compound with hydrogenation of at least one, preferably all, of the functional groups mentioned, more preferably one or more groups selected from carboxylic acid group and carboxylic ester group, in particular carboxylic ester group, in particular with conversion of the group or groups mentioned to one or more groups of the structure —CH₂OH. This hydrogenation may advantageously be carried out at a partial hydrogen pressure in the range from 10 to 30 MPa. In the hydrogenation, an average mean residence time of the monoolefinically unsaturated compound which bears at least two functional groups which are each independently selected from the group consisting of nitrile group, carboxylic acid group, carboxylic ester group and carboxamide group in the range from 0.1 to 100 hours has been found to be advantageous. In addition, a useful temperature for the hydrogenation is in the range from 200° C. to 350° C.

The advantages of the hydrogenation become particularly apparent when at least 0.5%, preferably at least 1%, in particular at least 5%, of the monoolefinically unsaturated compound used which bears at least two functional groups which are each independently selected from the group consisting of nitrile group, carboxylic acid group, carboxylic ester group and carboxamide group is hydrogenated to a saturated compound which bears the same at least two functional groups.

In a preferred embodiment component a) may be depleted from the mixture obtained in the addition or in the hydrogenation.

This may be effected by processes known per se, such as distillation, extraction or membrane processes, preferably by distillation.

The distillation may advantageously be carried out at a bottom temperature in the range from 50 to 200° C., preferably from 60 to 160° C., in particular from 70 to 150° C.

In this case, useful pressures, measured in the bottom of the distillation apparatus, are in the range from 0.05 to 50 kPa, preferably from 0.1 to 10 kPa, in particular from 0.2 to 6 kPa.

Average mean residence times in the range from 1 to 45 minutes, preferably from 5 to 35 minutes, in particular from 10 to 25 minutes, have been found to be advantageous.

Useful apparatus for the distillation is apparatus which is customary for this purpose, as described, for example, in: Kirk-Othmer, Encyclopedia of Chemical Technology, 3^{rd} Ed., Vol. 7, John Wiley & Sons, New York, 1979, pages 870-881, such as sieve tray columns, bubble-cap tray columns, columns having structured or random packings, dual-flow tray columns, valve tray columns or one-stage evaporators, such as falling-film evaporators, thin-film evaporators or flash evaporators.

The distillation may be carried out in a plurality of, such as 2 or 3, apparatus, advantageously a single apparatus.

The component obtained as top product in such a distillation may, if desired, be worked up or further processed by processes known per se.

When the top product obtained was an unsaturated compound, it may be hydrogenated to a saturated compound by processes known per se. For example, an unsaturated dicarboxylic acid or its ester such as diester, for example butenedicarboxylic acid or its mono- or diester, may be converted to corresponding saturated dicarboxylic acid or its ester such as diester, for example adipic acid or its mono- or diester, or to the corresponding, in particular saturated, alcohol, for example hexane-1,6-diol.

When the top product obtained in the distillation was a diester such as adipic diester or butenedicarboxylic diester, it may advantageously be reacted, for example, with a terminally unsaturated carboxylic acid such as acrylic acid to obtain a dicarboxylic acid such as butenedicarboxylic acid or adipic acid, and the corresponding ester of the terminally unsaturated carboxylic acid. Such processes are described, for example, in the German application 10240781.9.

According to the invention, a mixture comprising components a), b) and c) is separated by means of a semipermeable membrane to obtain a permeate and a retentate, in such a way that the weight ratio of component b) to component c) in the mixture fed to the semipermeable membrane is smaller than in the retentate.

Useful semipermeable membranes are preferably those which have a higher permeability for component c) than for component b).

Moreover, useful semipermeable membranes are preferably those which have a higher permeability for component a) than for component b).

A separation layer of the semipermeable membranes may comprise one or more materials selected from the group consisting of organic polymer, ceramic materials, metals and carbon or combinations thereof. They should be stable in the feed medium at the filtration temperature.

Useful ceramics are preferably alpha-aluminum oxide, zirconium oxide, titanium dioxide, silicon carbide or mixed ceramic materials.

The organic polymer used may advantageously be polypropylene, polytetrafluoroethylene, polyvinylidene difluoride, polysulfone, polyethersulfone, polyetherketone, polyamide, polyimide, polyacrylonitrile, regenerated cellulose or silicone.

For mechanical reasons, the separation layers are generally applied to a single-layer or multilayer porous substructure made of the same or a different material to the separation layer. The sublayer generally has coarser pores than the separation layer. Examples of advantageous material combinations are listed in the table which follows:

| Separation layer | Sublayer |
|---|---|
| Metal | Metal |
| Ceramic | Metal, ceramic or carbon |
| Polymer | Polymer, metal, ceramic or ceramic on metal |
| Carbon | Carbon, metal or ceramic |

The mean average pore size of the membrane should advantageously be in the range from 0.9 to 50 nm, in particular from 3 to 20 nm, in the case of inorganic membranes. The separation limits should preferably be in the range from 500 to 100 000 daltons, in particular in the range from 2 000 to 40 000 daltons, in the case of organic membranes.

The membranes may be used in various geometries, such as flat, tubular, multichannel, capillary or coil geometry, for which appropriate pressure casings which enable separation between retentate and permeate are available.

The optimum transmembrane pressures are dependent substantially upon the diameter of the membrane pores, the hydrodynamic conditions which influence the top layer structure, and the mechanical stability of the membrane at the filtration temperature.

In a preferred embodiment, the transmembrane pressure may be in the range from 0.02 to 10 MPa, in particular from 0.1 to 6 MPa.

The ratio of the pressure on the retentate side to the pressure on the permeate side of the membrane may preferably be in the range from 2 to 100.

On the retentate side, a pressure in the range from 0.1 to 10 MPa may advantageously be applied.

On the permeate side, a pressure in the range from 1 to 1000 kPa may advantageously be applied.

The membrane separation may be carried out in particular at a temperature in the range from 0 to 150° C.

In order to prevent significant build up of a top layer of component b) which leads to a distinct reduction in the permeate flux, it has been found that pumped circulation, mechanical movement of the membrane or stirrer units between the membranes are useful, in particular for generating a relative speed between membrane and suspension in the range from 0.1 to 10 m/s.

The permeate fluxes should advantageously be in the range from 1 to 50 kg/m²/h.

The membrane separation may be effected continuously, for example by single pass through one or more membrane separation stages connected in series.

The membrane separation may be discontinuous, for example by repeated passage through the membrane modules.

In the membrane separation, assistants may be used. In this context, the use of component a) as removed for example from the product stream beforehand has preferably been found to be advantageous, in particular to the extent to which component a) has been removed as permeate.

Component a) may then be removed from the retentate by processes known per se, for example by distillation, extraction, membrane separation, preferably by distillation.

The parameters and apparatus which have already been described for the distillative removal of component a) from the product stream of the addition or of the hydrogenation are useful for this purpose.

In a preferred embodiment, the permeate obtained in the process according to the invention may be partly or fully recycled into the addition mentioned or the hydrogenation mentioned, preferably the addition, as the compound which is homogeneous with respect to the reaction mixture and is suitable as a catalyst.

### EXAMPLES

### Definitions

Transmembrane pressure:
TMP=((P_{module inlet}+P_{module outlet})/2)−Pₚₑᵣₘₑₐₜₑ

Solvent exchange coefficient in the diafiltration:
MA=diafiltration agent addition (kg)/system capacity (kg)

### Example 1

Dimerization of a functionalized olefin, the distillative removal of the homogeneous catalyst and the removal of high boilers by membrane separation

A stirred glass autoclave having a capacity of 750 ml and a stirred glass autoclave having a capacity of 400 ml are connected in series as reactors R1 and R2 respectively. With the aid of a pump P1, MA is fed as the reactant to the first autoclave. The feed is via an immersed pipe into the liquid space of R1. Hydrogen is introduced in gaseous form, likewise via this line, using a mass flow regulator F1. The level of R1 is adjusted using a second immersed pipe, which serves as the overflow to R2. Gaseous hydrogen is likewise metered into the overflow line to R2 via a mass flow regulator F2. The feed to R2 is likewise introduced into R2 via an immersed pipe and the effluent from R2 is conducted through a further immersed pipe using a pressure regulating valve from Reco into a thin-film evaporator having an evaporator surface area of 0.046 m². The evaporator is adjusted to a predetermined pressure using a vacuum unit. The evaporator is heated using an oil bath W1. The temperature in W1 is used to control the level in the runoff vessel of the thin-film evaporator. From this vessel, a pump P2 conveys a cycle stream through the evaporator and a further pump P3 conveys a recycle stream from this cycle into the reactor R1, said recycle stream likewise being introduced through the immersed pipe through which the MA feed is also metered in. The pumps P1 and P3 likewise convey the same volumes per unit time. The vapor stream of the evaporator is conducted through an intensive cooler and condensed there. The condensate is subsequently collected (effluent). The constituents which are not condensed under these conditions are subjected to a condensation at atmospheric pressure and collected in a cold trap.

Operation of the continuous dimerization and catalyst removal:

At the start of the experiment, the reactors are charged with a solution which contains CP*Rh(C₂H₄)₂ and a stoichiometric amount of HBAr^{F}₄ and also 250 ppm of PTZ in HDME. To achieve uniform mixing, the reaction mixture is initially circulated at room temperature for approx. 20 h. Afterward, the thin-film evaporator is preheated to a start temperature of 100° C. The hydrogen stream and the MA feed (120 ml/h, contains 100 ppm by weight of PTZ) are then started, the reactors are heated to 70° C. and the evaporator is operated under reduced pressure.

In the steady state, a rhodium concentration of 190 ppm is determined for R1. In a representative assessment period of 18 h, the following results are obtained:

| | |
|---|---|
| Feed: | 2264 g |
| Cold trap: | 222 g (81% MA) |
| Effluent: | 2036 g (95% unsaturated linear diesters, |
| | 4% MA, approx. 0.5% DMA). |

After a series of assessments, the proportion of high boilers in the catalyst circuit increases. Therefore, a portion of the recycle stream is discharged and diluted with MA to a total weight of 3002.6 g. The composition of the solution is characterized as follows:

| | |
|---|---|
| Rh: | 16 ppm |
| High boilers: | 65 g/kg |
| | (residue determination: evaporation in vacuo at 250° C.) |

The solution is subjected to a continuous membrane filtration which is described in detail in example 4.

The MA- and rhodium catalyst-containing permeate for example 4 could be used directly as the feed in the continuous plant for dimerization and thus recycling of the catalyst could be achieved with simultaneous removal of the polymer.

### Example 2

Dimerization of a functionalized olefin with the hydrogenation of the C—C double bond of the product with a rhodium catalyst and distillative removal of the homogeneous catalyst and the removal of high boilers by membrane separation

A laboratory apparatus as described in example 1 is used, except that the feed is not metered into R1, but rather into R2.

At the start of the experiment, the reactors are charged with a solution which contains Cp*Rh(C₂H₄)₂ and a stoichiometric amount of HBAr^{F}₄ and also 250 ppm of PTZ in HDME. To achieve uniform mixing, the reaction mixture is initially circulated at room temperature for approx. 20 h. Afterward, the thin-film evaporator is preheated to a start temperature of 100° C. The hydrogen stream and the MA feed (120 ml/h, contains 100 ppm by weight of PTZ) are then started, the reactors are heated to 70° C. and the evaporator is operated under reduced pressure. The hydrogen in this example contains 50 ppm of O₂.

After several days, a steady state has been attained. In a representative assessment period of 18 h, the following results are obtained.

| | |
|---|---|
| Rh conc. R1: | 175 ppm |
| Rh conc. R2: | 110 ppm |
| Feed: | 725 g |
| Cold trap: | 383 g (99% MA) |
| Effluent: | 284 g |
| | (63% unsaturated linear diesters, 20% DMA, 17% MA) |

The polymer formed may be removed as described in examples 3-5.

### Examples 3-5

### Membrane Filtration

Removal of the homogeneously dissolved rhodium catalyst from high-boiling compounds

For the experiments, a thermostattable circulation apparatus having a minimum holdup of 3 l was used.

In the circuit were integrated a reservoir, a pump for pressure generation and flow through the membrane, a heat exchanger to maintain the temperature, a membrane module having incorporated ceramic tubular membrane and a pressure-retaining valve. The permeate runoff was under atmospheric pressure. It was possible using a level control to keep the holdup of the plant constant (diafiltration mode). All reservoirs of the apparatus were inertized with nitrogen. The ceramic tubular membrane used (from Inocermic GmbH) had an external diameter of 10 mm, an internal diameter of 7 mm and a length of 1000 mm. The support element consisted of Al₂O₃ and the internally supplied separation layer contained 5 nm pores of TiO₂. The flow to the membrane was from the inside and the permeate removed on the outside.

General Experimental Description

3 kg of distillation bottoms were introduced into the circulation vessel, then the pump was started with closed permeate passage and the pressure upstream of the membrane, the transverse flow rate and the temperature were brought to the desired value. The temperature was 40° C. and the transverse flow rate 4 m/s in the membrane tube. The permeate passage was then opened and the supply of the diafiltration medium activated. After a certain permeate removal and the equal supply of diafiltration medium, the experiment was terminated. The retentate use, retentate discharge and the mixed permeate were then analyzed with regard to the high boilers (polymer) and catalyst.

The table which follows contains the results of continuous membrane filtrations, whose parameters have been described above. Example 4 describes the membrane filtration of a substream from example 1.

TABLE 1
Results of the membrane filtrations

| | | | Retentate use | | | | Retentate discharge | | | | | | Permeate discharge | | |
|---|---|---|---|---|---|---|---|---|---|---|---|---|---|---|---|
| | | Permeate | m | | | Rh/ | m | | | Rh/ | Diafil- | | m | | |
| Example | TMP | flux | (kg) | Polymer | Rh | Polymer | (kg) | Polymer | Rh | Polymer | tration | | (kg) | Polymer | Rh |
| No. | (bar) | (kg/m²/h) | (kg) | (%) | (ppm) | (ppm/%) | (kg) | (%) | (ppm) | (ppm/%) | medium | MA | (kg) | (%) | (ppm) |
| 3 | 5 | 13 | 3.2 | 1.0 | 360 | 360 | 3.2 | 1 | 55 | 55 | HDME | 3.4 | 10.8 | n.d. | 92 |
| 4 | 5 | 15 | 3.6 | 6.5 | 16.0 | 2.46 | 3.6 | 6.5 | 3.5 | 0.54 | Methyl | 2.5 | 9.1 | n.d. | 5.0 |
| | | | | | | | | | | | acrylate | | | | |
| 5 | 1 | 18 | 3.0 | 4.8 | 100 | 20.8 | 3.0 | 4.8 | 85 | 17.7 | Acetone | 2.7 | 8.3 | n.d. | 5.5 |

n.d. = not detectable

We claim:

1. A process for separating a mixture comprising
a) a monoolefinically unsaturated compound which is obtainable by adding two terminal olefins which bear the functional groups required to prepare the monoolefinically unsaturated compound containing at least two functional groups, or a saturated compound obtained by hydrogenating such a compound,
b) a compound which is obtainable by adding more than two of the terminal olefins mentioned in a) or a compound obtained by hydrogenating such a compound, and
c) a compound which contains a transition metal, is homogeneous with respect to the mixture and is suitable as a catalyst for preparing a monoolefinically unsaturated compound by adding two terminal olefins which bear the functional groups required to prepare the monoolefinically unsaturated compound containing at least two functional groups,
by means of a semipermeable membrane to obtain a permeate and a retentate in such a way that the weight ratio of component b) to component c) in the mixture fed to the semipermeable membrane is smaller than in the retentate.

2. A process as claimed in claim 1, wherein the component c) used is a rhodium-, ruthenium-, palladium- or nickel-containing compound.

3. A process as claimed in claim 1, wherein the component c) used is a rhodium-containing compound.

4. A process as claimed in any of claims 1 to 3, wherein the component c) used is a rhodium-containing compound which is homogeneous with respect to the mixture and is of the formula [L¹RhL²L³R]⁺X⁻ where
L¹ is an anionic pentahapto ligand;
L² is an uncharged 2-electron donor;
L³ is an uncharged 2-electron donor;
R is selected from the group consisting of H, C₁-C₁₀-alkyl, C₆-C₁₀-aryl and C₇-C₁₀-aralkyl ligands;
X⁻ is an uncoordinating anion;
and where two or three of L², L³ and R are optionally joined.

5. A process as claimed in claim 4, wherein L¹ is pentamethylcyclopentadienyl.

6. A process as claimed in either of claims 4 and 5, wherein X⁻ is selected from the group consisting of BF₄⁻, B(perfluorophenyl)₄⁻, B(3,5-bis(trifluoromethyl)phenyl)₄⁻, Al(ORF)₄⁻ where R^{F} is identical or different fluorinated or perfluorinated aliphatic or aromatic radicals.

7. A process as claimed in any of claims 4 to 6, wherein L² and L³ are each independently selected from the group consisting of C₂H₄, CH₂═CHCO₂Me, P(OMe)₃ and MeO₂C—(C₄H₆)—CO₂Me.

8. A process as claimed in any of claims 4 to 6, wherein L² and L³ together are selected from the group consisting of acrylonitrile and 5-cyanopentenoic ester.

9. A process as claimed in any of claims 4 to 7, wherein L² and R together are —CH₂—CH₂CO₂Me.

10. A process as claimed in any of claims 4 to 7 or 9, wherein L², L³ and R together are MeO₂C(CH₂)₂—(CH)—(CH₂)CO₂Me.

11. A process as claimed in claim 3, wherein the component c) used is a compound selected from the group consisting of
[Cp*Rh(C₂H₄)₂H]⁺BF₄⁻,
[Cp*Rh(P(OMe)₃)(CH₂═CHCO₂Me)(Me)]⁺BF₄⁻,
[Cp*Rh(—CH₂—CH₂CO₂Me)(P(OMe)₃)]⁺BF₄⁻,
[Cp*Rh(MeO₂C(CH₂)₂—(CH—)—(CH₂)CO₂Me)]⁺BF₄⁻,
[Cp*Rh(C₂H₄)₂H]⁺B(3,5-bis(trifluoromethyl)phenyl)₄⁻,
[Cp*Rh(P(OMe)₃)(CH₂═CHCO₂Me)(Me)]⁺B(3,5-bis(trifluoromethyl)phenyl)₄⁻,
[Cp*Rh(—CH₂—CH₂CO₂Me)(P(OMe)₃)]⁺B(3,5-bis(trifluoromethyl)phenyl)₄⁻,
[Cp*Rh(MeO₂C(CH₂)₂—(CH—)—(CH₂)CO₂Me)]⁺B(3,5-bis(trifluoromethyl)phenyl)₄⁻,
[Cp*Rh(C₂H₄)₂H]⁺B(perfluorophenyl)₄⁻,
[Cp*Rh(P(OMe)₃)(CH₂═CHCO₂Me)(Me)]⁺B(perfluorophenyl)₄⁻,
[Cp*Rh(—CH₂—CH₂CO₂Me)(P(OMe)₃)]⁺B(perfluorophenyl)₄⁻ [Cp*Rh(MeO₂C(CH₂)₂—(CH—)—(CH₂)CO₂Me)]⁺B(perfluorophenyl)₄⁻,
[Cp*Rh(C₂H₄)₂H]⁺Al(ORF)₄⁻,
[Cp*Rh(P(OMe)₃)(CH₂═CHCO₂Me)(Me)]⁺Al(ORF)₄⁻,
[Cp*Rh(—CH₂—CH₂CO₂Me)(P(OMe)₃)]⁺Al(ORF)₄⁻ and
[Cp*Rh(MeO₂C(CH₂)₂—(CH—)—(CH₂)CO₂Me)]⁺Al(ORF)₄⁻,
where R^{F} is identical or different part-fluorinated or perfluorinated aliphatic or aromatic radicals.

12. A process as claimed in any of claims 1 to 11, wherein the compound a) used is a compound selected from the group consisting of adipic diester, adiponitrile, 5-cyanovaleric ester, 1,4-butenedinitrile, 5-cyanopentenoic ester and hexenedioic diester.

13. A process as claimed in any of claims 1 to 12, wherein a membrane which comprises substantially one or more organic or inorganic materials.

14. A process as claimed in any of claims 1 to 13, wherein the mean average pore size of the membrane is in the range from 0.9 to 50 nm in the case of inorganic membranes.

15. A process as claimed in any of claims 1 to 13, wherein the mean average separation limit of the membrane is in the range from 500 to 100000 daltons in the case of organic membranes.

16. A process as claimed in any of claims 1 to 15, wherein the ratio of the pressure on the retentate side of the membrane to the pressure on the permeate side of the membrane is in the range from 2 to 100.

17. A process as claimed in any of claims 1 to 16, wherein a pressure in the range from 0.1 to 10 MPa is applied on the retentate side of the membrane.

18. A process as claimed in any of claims 1 to 17, wherein a pressure in the range from 1 to 1000 kPa is applied on the permeate side of the membrane.

19. A process as claimed in any of claims 1 to 18, wherein the membrane separation is carried out at a temperature in the range from 0 to 150° C.
